(19) United States
(12) Patent Application Publication
(10) Pub. No.: US 2011/0069046 A1
(43) Pub. Date: Mar. 24, 2011

(54) PIXEL ARRAY AND DRIVING METHOD THEREOF AND DISPLAY PANEL EMPLOYING THE PIXEL ARRAY

(75) Inventors: Jui-Feng KO, Miao-Li County (TW); Cheng-Hsiu LEE, Miao-Li County (TW); Yi-Zhong SHEU, Miao-Li County (TW)

(73) Assignee: CHIMEI INNOLUX CORPORATION, Miao-Li County (TW)

(21) Appl. No.: 12/852,526

(22) Filed: Aug. 9, 2010

(30) Foreign Application Priority Data
Sep. 18, 2009 (CN) 200910307300.3

(51) Int. Cl. G09G 5/00

(52) U.S. Cl. 345/204

(57) ABSTRACT

A pixel array includes pixels, scan lines, data lines, and a source driving circuit. Herein, P(2m,n) is expressed as the pixel on a 2m^{th} column and a n^{th} row, G(2n) is expressed as the 2n^{th} scan line, X(m) is expressed as the m^{th} data line. The scan line G(2n−1) is coupled to control ends of the pixels P(2m−1,n) and P(2m+2,n). The scan line G(2n) is coupled to control ends of the pixels P(2m,n) and P(2m+1,n). The scan line G(2n−1) is coupled to control ends of the pixels P(2m−1,n) and P(2m+2,n). During the t^{th} frame period, the source driving circuit respectively and sequentially drives the pixels P(2m−1,n), P(2m,n), P(2m−1,n+1), P(2m,n+1), P(2m−1,n+2), P(2m,n+2), P(2m−1,n+3), and P(2m,n+3) in “positive polarity, negative polarity, negative polarity, positive polarity, negative polarity, positive polarity, positive polarity, and negative polarity” through the data line X(m).

### BACKGROUND

1. Technical Field

The disclosure relates to a pixel array, a driving method thereof, and a display panel employing the pixel array. More particularly, the disclosure relates to a dual gate pixel array, a driving method thereof, and a display panel employing the dual gate pixel array.

2. Description of Related Art

With the need for larger display panels, so-called dual gate pixel arrays are developed in the structures of LCD panels. In dual gate pixel arrays, two scan lines are disposed in an identical pixel row. In the identical pixel row, two adjacent pixels share a data line, such that the number of data lines is reduced into a half. Accordingly, the cost of source drivers is relatively reduced. In the typical technology, the two adjacent pixels sharing the same data line are driven in the same polarity by the source drivers.

When the flickering of the LCD panel is tested, the methods for dual gate pixel arrays and non-dual gate pixel arrays are different. It may cause the process to be more complex.

### SUMMARY

A pixel array including a plurality of pixels, a plurality of scan lines, a plurality of data lines, and a source driving circuit is provided in an embodiment of the disclosure. Herein, P(2m,n) is expressed as the pixel on a 2m^{th} column and a n^{th} row, G(2n) is expressed as the 2n^{th} scan line, X(m) is expressed as the m^{th} data line, and m and n are integers. The scan line G(2n−1) is coupled to control ends of the pixels P(2m−1,n) and P(2m+2,n). The scan line G(2n) is coupled to control ends of the pixels P(2m,n) and P(2m+1,n). The scan line G(2n−1) is coupled to control ends of the pixels P(2m−1,n) and P(2m+2,n). During a t^{th} frame period, the source driving circuit respectively and sequentially drives the pixels P(2m−1,n), P(2m,n), P(2m−1,n+1), P(2m,n+1), P(2m−1,n+2), P(2m,n+2), P(2m−1,n+3), and P(2m,n+3) in “positive polarity, negative polarity, negative polarity, positive polarity, negative polarity, positive polarity, positive polarity, and negative polarity” through the data line X(m), wherein t is an integer.

An embodiment of the disclosure provides a driving method to drive the foregoing pixel array. The driving method includes: during a t^{th} frame period, respectively and sequentially driving the pixels P(2m−1,n), P(2m,n), P(2m−1,n+1), P(2m,n+1), P(2m−1,n+2), P(2m,n+2), P(2m−1,n+3), and P(2m,n+3) in “positive polarity, negative polarity, negative polarity, positive polarity, negative polarity, positive polarity, positive polarity, and negative polarity” through the data line X(m), wherein t is an integer.

In an embodiment of the disclosure, a display panel including a plurality of pixels, a plurality of scan lines, and a plurality of data lines is provided. Herein, P(2m,n) is expressed as the pixel on a 2m^{th} column and a n^{th} row, G(2n) is expressed as the 2n^{th} scan line, X(m) is expressed as the m^{th} data line, and m and n are integers. The scan line G(2n−1) is coupled to control ends of the pixels P(2m−1,n) and P(2m+2,n). The scan line G(2n) is coupled to control ends of the pixels P(2m,n) and P(2m+1,n). The scan line G(2n−1) is coupled to control ends of the pixels P(2m−1,n) and P(2m+2,n). The data line X(m+1) is coupled to data ends of the pixels P(2m+1,n) and P(2m+2,n).

In order to make the aforementioned and other features and advantages of the disclosure more comprehensible, embodiments accompanying figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a system block diagram of a flat panel display according to an embodiment of the disclosure.

FIG. 2A is a timing diagram showing signal waveforms of FIG. 1 during the t^{th} frame period F(t) according to an embodiment of the disclosure.

FIG. 2B illustrates driving sequences of the pixels in the dual gate display panel of FIG. 1 during the t^{th} frame period F(t) according to an embodiment of the disclosure.

FIG. 3A is a timing diagram showing signal waveforms of FIG. 1 during the (t+1)^{th} frame period F(t+1) according to an embodiment of the disclosure.

FIG. 3B illustrates driving sequences of the pixels in the dual gate display panel of FIG. 1 during the (t+1)^{th} frame period F(t+1) according to an embodiment of the disclosure.

### DETAILED DESCRIPTION

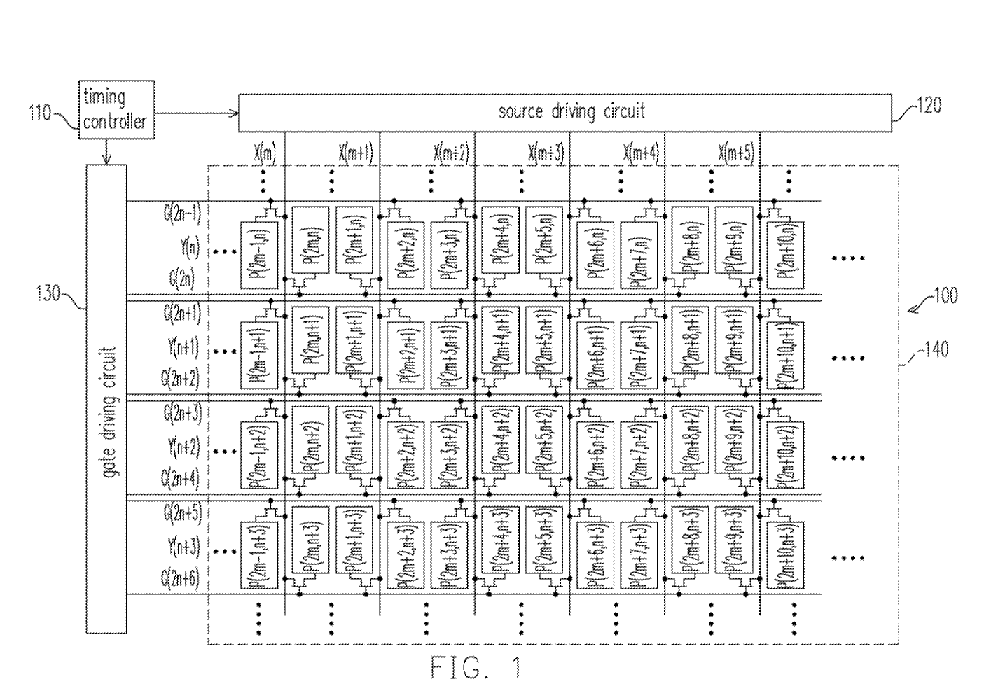

FIG. 1 is a system block diagram of a flat panel display 100 according to an embodiment of the disclosure. Referring to FIG. 1, the flat panel display 100 includes a timing controller 110, a source driving circuit 120, a gate driving circuit 130, and a dual gate display panel 140. In the present embodiment, the dual gate display panel 140 may be a liquid crystal display (LCD) panel. According to design requirements and processes, the source driving circuit 120 and/or the gate driving circuit 130 may be disposed on a glass substrate of a printed circuit board (PCB), a flexible circuit board, or the dual gate display panel 140. For example, the source driving circuit 120 of the present embodiment is disposed on the glass substrate of the dual gate display panel 140 to form a pixel array module.

The pixel array (or the dual gate display panel 140) also includes a plurality of pixels, a plurality of data lines, and a plurality of scan lines. In FIG. 1, P(2m,n) is expressed as the pixel on a 2m^{th} column and a n^{th} row, G(2n) is expressed as the 2n^{th} scan line, X(m) is expressed as the m^{th} data line, and m and n are integers. It should be noted that, the data line X(m) may be any data line in the dual gate display panel 140, and the scan lines G(2n−1) and G(2n) may be any two adjacent scan lines in the dual gate display panel 140.

The scan line G(2n−1) is coupled to control ends of the pixels P(2m−1,n) and P(2m+2,n). The scan line G(2n) is coupled to control ends of the pixels P(2m,n) and P(2m+1,n). The data line X(m) is coupled to data ends of the pixels P(2m−1,n) and P(2m,n). The data line X(m+1) is coupled to data ends of the pixels P(2m+1,n) and P(2m+2,n). The description of other pixels P(2m+3,n)˜P(2m+10,n), pixels P(2m−1,n+1)˜P(2m+10,n+1), pixels P(2m−1,n+2)˜P(2m+10,n+2), and pixels P(2m−1,n+3)˜P(2m+10,n+3) can refer to that of the foregoing pixels P(2m−1,n)˜P(2m+2,n) and are respectively coupled to the corresponding scan lines and data lines as shown in FIG. 1.

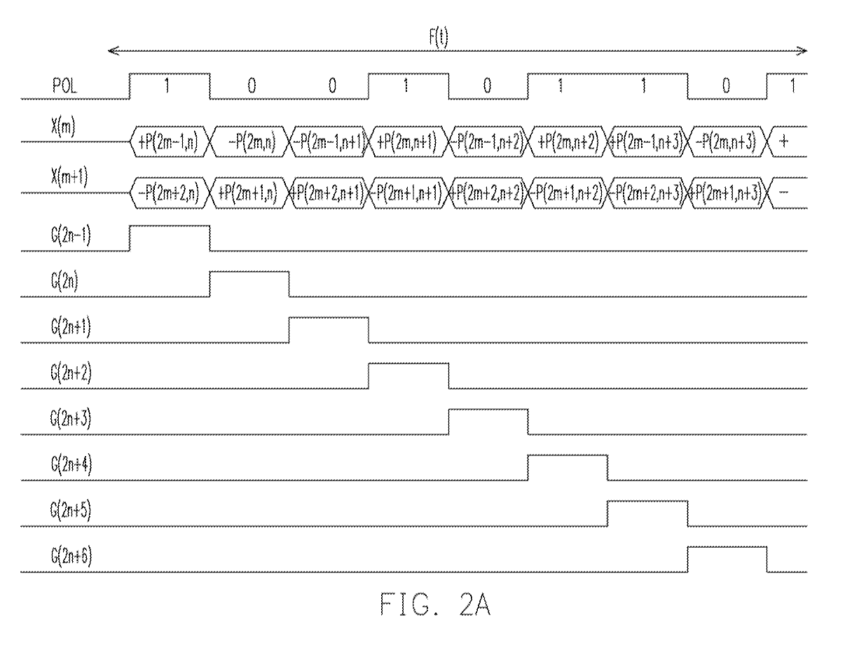

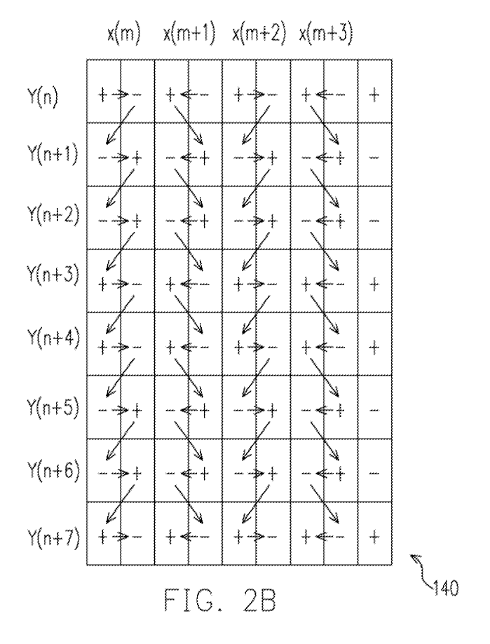

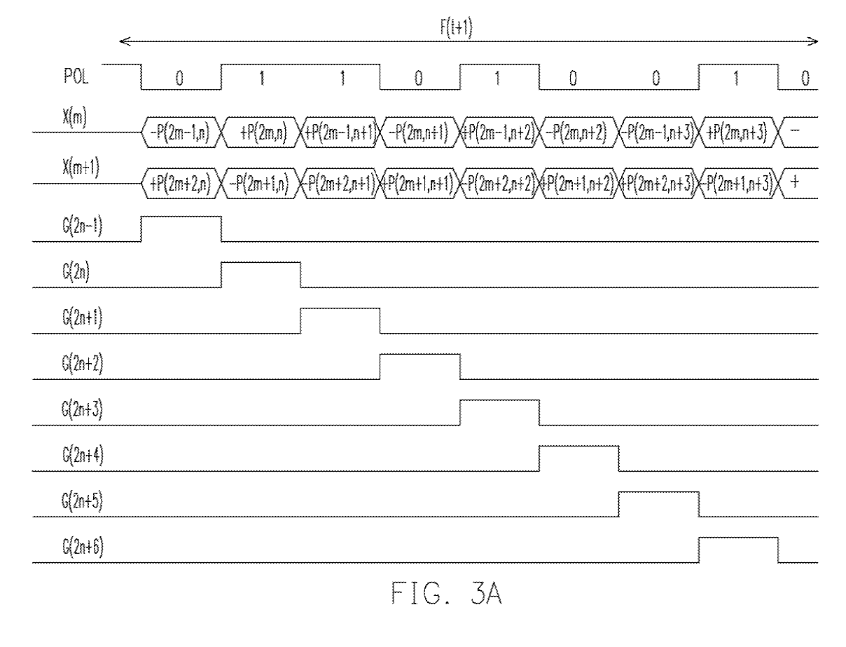

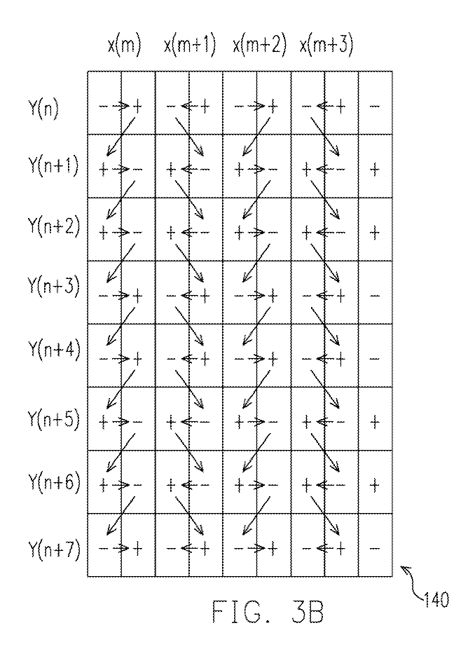

FIG. 2A is a timing diagram showing signal waveforms of FIG. 1 in a specific frame period (the t^{th} frame period F(t) hereinafter) according to an embodiment of the disclosure. FIG. 3A is a timing diagram showing signal waveforms of FIG. 1 in the next frame period (the (t+1)^{th} frame period F(t+1) hereinafter) according to an embodiment of the disclosure. In FIG. 2A, FIG. 2B, FIG. 3A, and FIG. 3B, the symbol “+” represents positive polarity, and the symbol “−” represents negative polarity.

Referring to FIG. 1 and FIG. 2A, the gate driving circuit 130 is controlled by the timing controller 110 to drive the scan lines in sequence as the signal waveforms of the scan lines G(2n−1)˜G(2n+6) shown in FIG. 2A. The pulses outputted by the scan lines G(2n−1)˜G(2n+6) turn on the corresponding pixels in the dual gate display panel 140. The source driving circuit 120 controlled by the timing controller 110 drives the data lines X(m)˜X(m+5) according to the timing of the gate driving circuit 130, so as to respectively write gray level data into the corresponding pixels.

According to the polarity control signal POL outputted by the timing controller 110, the source driving circuit 120 determines the polarity of the gray level data on the data lines X(m)˜X(m+5). It should be noted that, one full period of the polarity control signal POL is simply illustrated in FIG. 2, and the non-illustrated part can refer to the illustrated waveform and be realized in the similar way.

During the t^{th} frame period F(t), the polarity control signal POL outputted to the source driving circuit 120 by the timing controller 110 is “1, 0, 0, 1, 0, 1, 1, 0, 1, 0, 0, 1, 0, 1, 1, 0, . . . ” According to the polarity control signal POL, the source driving circuit 120 determines the polarity of the gray level data of the data line X(m) as “+ − − + − + + − + − − + − + + − . . . ,” (wherein the symbol “+” represents positive polarity, and the symbol “−” represents negative polarity) and determines the polarity of the gray level data of the data line X(m+1) as “− + + − + − − + − + + − + − − + . . . .” The polarity change of the data lines X(m+2) and X(m+4) are the same as the data line X(m), and the polarity change of the data lines X(m+3) and X(m+5) are the same as the data line X(m+1). Accordingly, based on the pulses of the scan lines G(2n−1)˜G(2n+6) shown in FIG. 2A, the source driving circuit 120 respectively and sequentially writes the gray level data with “positive polarity, negative polarity, negative polarity, positive polarity, negative polarity, positive polarity, positive polarity, and negative polarity” into the pixels P(2m−1,n), P(2m,n), P(2m−1,n+1), P(2m,n+1), P(2m−1,n+2), P(2m,n+2), P(2m−1,n+3), and P(2m,n+3) through the data line X(m) and at the same time, respectively and sequentially writes the gray level data with “negative polarity, positive polarity, positive polarity, negative polarity, positive polarity, negative polarity, negative polarity, and positive polarity” into the pixels P(2m+2,n), P(2m+1,n), P(2m+2,n+1), P(2m+1,n+1), P(2m+2,n+2), P(2m+1,n+2), P(2m+2,n+3), and P(2m+1,n+3) through the data line X(m+1).

FIG. 2B illustrates writing sequences (driving sequences) of the gray level data of the pixels in the dual gate display panel 140 of FIG. 1 during the t^{th} frame period F(t) according to an embodiment of the disclosure. As described above, according to the timing of the gate driving circuit 130, the source driving circuit 120 respectively and sequentially writes the gray level data with the polarity “+ − − + − + + − + − − + − + + − . . . ” into the corresponding pixels through the data line X(m) and at the same time, respectively and sequentially writes the gray level data with the polarity “− + + − + − − + − + + − + − − + . . . ” into the corresponding pixels through the data line X(m+1). For any of the pixel rows Y(n)˜Y(n+7), the polarity of each pixel is respectively “+ − + − + − + − . . . ” or “− + − + − + − + . . . .” For any of the pixel columns, the polarity of each pixel is respectively “+ − − + + − − + . . . ” or “− + + − − + + − . . . .” Accordingly, the polarity technology of “1+2 line dot inversion” is achieved in the dual gate pixel array 140 under the condition of which the circuit design of the source driving circuit and the gate driving circuit are unchanged. Through an exemplary embodiment of the disclosure, the method for testing the flicking of the non-dual gate pixel array is applied to test that of the dual gate pixel array provided in an exemplary embodiment of the disclosure.

Referring to FIG. 1 and FIG. 3A, during the (t+1)^{th} frame period F(t+1), the polarity control signal POL outputted to the source driving circuit 120 by the timing controller 110 is “0, 1, 1, 0, 1, 0, 0, 1, 0, 1, 1, 0, 1, 0, 0, 1, . . . .” According to the polarity control signal POL, the source driving circuit 120 determines the polarity of the gray level data of the data line X(m) as “− + + − + − − + − + + − + − − + . . . ,” and determines the polarity of the gray level data of the data line X(m+1) as “+ − − + − + + − + − − + − + + − . . . .” Accordingly, based on the pulses of the scan lines G(2n−1)˜G(2n+6) shown in FIG. 3A, the source driving circuit 120 respectively and sequentially writes the gray level data with “negative polarity, positive polarity, positive polarity, negative polarity, positive polarity, negative polarity, negative polarity, and positive polarity” into the pixels P(2m−1,n), P(2m,n), P(2m−1,n+1), P(2m,n+1), P(2m−1,n+2), P(2m,n+2), P(2m−1,n+3), and P(2m,n+3) through the data line X(m) and at the same time, respectively and sequentially writes the gray level data with “positive polarity, negative polarity, negative polarity, positive polarity, negative polarity, positive polarity, positive polarity, and negative polarity” into the pixels P(2m+2,n), P(2m+1,n), P(2m+2,n+1), P(2m+1,n+1), P(2m+2,n+2), P(2m+1,n+2), P(2m+2,n+3), and P(2m+1,n+3) through the data line X(m+1).

FIG. 3B illustrates writing sequences (driving sequences) of the gray level data of the pixels in the dual gate display panel 140 of FIG. 1 during the (t+1)^{th} frame period F(t+1) according to an embodiment of the disclosure. As described above, according to the timing of the gate driving circuit 130, the source driving circuit 120 respectively and sequentially writes the gray level data with the polarity “− + + − + − − + − + + − + − − + . . . ” into the corresponding pixels through the data line X(m) and at the same time, respectively and sequentially writes the gray level data with the polarity “+ − − + − + + − + − − + − + + − . . . ” into the corresponding pixels through the data line X(m+1). For any of the pixel rows Y(n)˜Y(n+7), the polarity of each pixel is respectively “− + − + − + − + . . . ” or “+ − + − + − + − . . . .” For any of the pixel columns, the polarity of each pixel is respectively “− + + − − + + − . . . ” or “+ − − + + − − + . . . .” Accordingly, during the (t+1)^{th} frame period F(t+1), the polarity technology of “1+2 line dot inversion” is still realized in the dual gate pixel array 140 in the present embodiment.

Base on the above, the pixel array and the driving method thereof are provided in an embodiment of the disclosure. The polarity technology of “1+2 line dot inversion” is achieved in the dual gate pixel array under the condition of which the source driving circuit and the gate driving circuit are unchanged. Furthermore, the method for testing the flicking of the non-dual gate pixel array is also used for testing that of the dual gate pixel array.

Although the disclosure has been described with reference to the above embodiments, it will be apparent to one of the ordinary skill in the art that modifications to the described embodiment may be made without departing from the spirit of the disclosure. Accordingly, the scope of the disclosure will be defined by the attached claims not by the above detailed descriptions.

What is claimed is:

1. A pixel array, comprising:
a plurality of pixels, wherein the pixel on a 2 m^{th} column and a n^{th} row is expressed as P(2m,n), and m and n are integers;
a plurality of scan lines, wherein the 2n^{th} scan line is expressed as G(2n), the scan line G(2n−1) is coupled to control ends of the pixels P(2m−1,n) and P(2m+2,n), and the scan line G(2n) is coupled to control ends of the pixels P(2m,n) and P(2m+1,n);
a plurality of data lines, wherein the m^{th} data line is expressed as X(m), and the data line X(m) is coupled to data ends of the pixels P(2m−1,n) and P(2m,n); and
a source driving circuit electrically coupled to the data lines, wherein during a t^{th} frame period, the source driving circuit respectively and sequentially drives the pixels P(2m−1,n), P(2m,n), P(2m−1,n+1), P(2m,n+1), P(2m−1,n+2), P(2m,n+2), P(2m−1,n+3), and P(2m,n+3) in “positive polarity, negative polarity, negative polarity, positive polarity, negative polarity, positive polarity, positive polarity, and negative polarity” through the data line X(m), wherein t is an integer.

2. The pixel array as claimed in claim 1, wherein during the t^{th} frame period, the source driving circuit respectively and sequentially drives the pixels P(2m+2,n), P(2m+1,n), P(2m+2,n+1), P(2m+1,n+1), P(2m+2,n+2), P(2m+1,n+2), P(2m+2,n+3), and P(2m+1,n+3) in “negative polarity, positive polarity, positive polarity, negative polarity, positive polarity, negative polarity, negative polarity, and positive polarity” through the data line X(m+1).

3. The pixel array as claimed in claim 1, wherein during a (t+1)^{th} frame period, the source driving circuit respectively and sequentially drives the pixels P(2m−1,n), P(2m,n), P(2m−1,n+1), P(2m,n+1), P(2m−1,n+2), P(2m,n+2), P(2m−1,n+3), and P(2m,n+3) in “negative polarity, positive polarity, positive polarity, negative polarity, positive polarity, negative polarity, negative polarity, and positive polarity” through the data line X(m).

4. The pixel array as claimed in claim 3, wherein during the (t+1)^{th} frame period, the source driving circuit respectively and sequentially drives the pixels P(2m+2,n), P(2m+1,n), P(2m+2,n+1), P(2m+1,n+1), P(2m+2,n+2), P(2m+1,n+2), P(2m+2,n+3), and P(2m+1,n+3) in “positive polarity, negative polarity, negative polarity, positive polarity, negative polarity, positive polarity, positive polarity, and negative polarity” through the data line X(m+1).

5. The pixel array as claimed in 1, further comprising:
a gate driving circuit electrically coupled to the scan lines, wherein the gate driving circuit drives the scan lines in sequence according to a timing of the source driving circuit.

6. A driving method of a pixel array, wherein the pixel array comprises the pixel array as claimed in claim 1, the driving method comprising:
during a t^{th} frame period, respectively and sequentially driving the pixels P(2m−1,n), P(2m,n), P(2m−1,n+1), P(2m,n+1), P(2m−1,n+2), P(2m,n+2), P(2m−1,n+3), and P(2m,n+3) in “positive polarity, negative polarity, negative polarity, positive polarity, negative polarity, positive polarity, positive polarity, and negative polarity” through the data line X(m), wherein t is an integer.

7. The driving method of the pixel array as claimed in claim 6, further comprising:
during the t^{th} frame period, respectively and sequentially driving the pixels P(2m+2,n), P(2m+1,n), P(2m+2,n+1), P(2m+1,n+1), P(2m+2,n+2), P(2m+1,n+2), P(2m+2,n+3), and P(2m+1,n+3) in “negative polarity, positive polarity, positive polarity, negative polarity, positive polarity, negative polarity, negative polarity, and positive polarity” through the data line X(m+1).

8. The driving method of the pixel array as claimed in claim 6, further comprising:
during a (t+1)^{th} frame period, respectively and sequentially driving the pixels P(2m−1,n), P(2m,n), P(2m−1,n+1), P(2m,n+1), P(2m−1,n+2), P(2m,n+2), P(2m−1,n+3), and P(2m,n+3) in “negative polarity, positive polarity, positive polarity, negative polarity, positive polarity, negative polarity, negative polarity, and positive polarity” through the data line X(m).

9. The driving method of the pixel array as claimed in claim 8, further comprising:
during the (t+1)^{th} frame period, respectively and sequentially driving the pixels P(2m+2,n), P(2m+1,n), P(2m+2,n+1), P(2m+1,n+1), P(2m+2,n+2), P(2m+1,n+2), P(2m+2,n+3), and P(2m+1,n+3) in “positive polarity, negative polarity, negative polarity, positive polarity, negative polarity, positive polarity, positive polarity, and negative polarity” through the data line X(m+1).

10. A display panel, comprising:
a plurality of pixels, wherein the pixel on a 2 m^{th} column and a n^{th} row is expressed as P(2m,n), and m and n are integer;
a plurality of scan lines, wherein the 2n^{th} scan line is expressed as G(2n), the scan line G(2n−1) is coupled to control ends of the pixels P(2m−1,n) and P(2m+2,n), and the scan line G(2n) is coupled to control ends of the pixels P(2m,n) and P(2m+1,n); and
a plurality of data lines, wherein the m^{th} data line is expressed as X(m), the data line X(m) is coupled to data ends of the pixels P(2m−1,n) and P(2m,n), and the data line X(m+1) is coupled to data ends of the pixels P(2m+1,n) and P(2m+2,n).

11. The display panel as claimed in claim 10, further comprising: a source driving circuit electrically coupled to the data lines.

12. The display panel as claimed in claim 11, further comprising: a gate driving circuit electrically coupled to the scan lines, wherein the gate driving circuit drives the scan lines in sequence according to a timing of the source driving circuit.
